(19) United States
(12) Patent Application Publication
(10) Pub. No.: US 2017/0045724 A1
(43) Pub. Date: Feb. 16, 2017

(54) MICROSCOPE MODULE AND MICROSCOPE DEVICE

(71) Applicant: Aidmics Biotechnology Co., Ltd., Taipei City (TW)

(72) Inventors: Cheng-Ming LIN, Taipei City (TW); Chang-Yu CHEN, Taipei City (TW); Shu-Sheng LIN, Taipei City (TW); Tsun-Chao CHIANG, Taipei City (TW)

(21) Appl. No.: 15/236,005

(22) Filed: Aug. 12, 2016

(30) Foreign Application Priority Data
Aug. 14, 2015 (TW) 104126632
Feb. 5, 2016 (TW) 105104128

(51) Int. Cl. G02B 21/08; G02B 21/00; F21V 8/00; G02B 21/34; G02B 21/02; G02B 13/00; G02B 21/36

(52) U.S. Cl. CPC G02B 21/082; G02B 13/0025; G02B 21/0008; G02B 21/365; G02B 21/34; G02B 21/02; G02B 6/0038; G02B 6/0088; G02B 13/002

(57) ABSTRACT

A microscope module includes a housing, a convex lens and a light guide element. The housing has a sample inspecting surface located on one side of the housing opposite to an image capturing module. The convex lens is disposed in the housing, and the shortest distance between the sample inspecting surface and the convex lens ranges from 0.1 mm to 3.0 mm. The light guide element is disposed on an external portion of the housing and has a light input portion and a light output portion. The light output portion is located between the image capturing module and the convex lens. The light input portion receives a light, and the light is outputted through the light output portion to the convex lens. The light passes through the convex lens and then reaches the sample inspecting surface. A microscope device including the microscope module is also disclosed.

### CROSS REFERENCE TO RELATED APPLICATIONS

This Non-provisional application claims priority under 35 U.S.C. §119(a) on Patent Application No(s). 104126632 filed in Taiwan, Republic of China on Aug. 14, 2015, and 105104128 filed in Taiwan, Republic of China on Feb. 5, 2016, the entire contents of which are hereby incorporated by reference.

### BACKGROUND OF THE INVENTION

Field of Invention

The present invention relates to a microscope module and a microscope device.

Related Art

The microscope is used for inspecting or measuring a very small sample, and can be applied to various research fields, such as the material science, fundamental biology, and biomedical science. In general, the microscopes include the transmission microscopes and reflective microscopes (also named optical microscopes). The transmission microscope is usually used to observe transparent or very thin samples. In practice, the light emitted from the light source can directly pass through the sample and then enter the microscope lenses for inspection of the bio tissue. In addition, the reflective microscope is usually used to observe opaque samples, such as metals or minerals, in the engineering or material sciences. In practice, the light source of the reflective microscope must pass through the polarizer to provide a polarized light, wherein a part of light is turned downward vertically and then projected on the surface of the sample through a lens. Afterwards, the surface of the sample reflects the light, which then passes through the object lens, polarizer, planar glass, and eyepiece in order, and enters the observer's eye. Accordingly, the observer can view the enlarged image of the surface of the sample.

As mentioned above, the reflective microscope includes the object lens, polarizer, planar glass, and eyepiece. In particular, the polarizer must be installed with a specific angle. Thus, the reflective microscope usually has a large volume. Besides, the reflective microscope has a complex structure and is hard to be carried to everywhere, so it is usually installed in the lab and operated by the professional operator. However, if the researcher can't inspect the samples until bringing the samples back the lab, many researches will be delayed, which causes the inconveniences of the operators. In other words, since the reflective microscope is usually applied to inspect the surface of the sample, it will sufficiently improve the utility if the reflective microscope is portable.

### SUMMARY OF THE INVENTION

In view of the foregoing, an objective of the present invention is to provide a microscope module and a microscope device that can be portable. In this invention, the novel designs of the convex lens and the light traveling path from the illumination assembly can sufficiently reduce the volumes of the microscope module and microscope device, thereby achieving the purpose of the portable microscope module and microscope device.

To achieve the above objective, the present invention discloses a microscope module, which is cooperated with an image capturing module and includes a housing, a convex lens and a light guide element. The housing has a sample inspecting surface located on one side of the housing, which is opposite to the image capturing module. The convex lens is disposed in the housing, and a shortest distance between the sample inspecting surface and the convex lens ranges from 0.1 mm to 3.0 mm. The light guide element is disposed on an external portion of the housing. The light guide element has a light input portion and a light output portion. The light output portion is located between the image capturing module and the convex lens. The light input portion receives a light, and the light is outputted through the light output portion to the convex lens. The light enters the convex lens through a light input surface of the convex lens, leaves the convex lens through a light output surface of the convex lens, and then reaches the sample inspecting surface.

To achieve the above objective, the present invention also discloses a microscope module, which is cooperated with an image capturing module and includes a sample inspecting surface, a convex lens and a light guide element. The sample inspecting surface is located at one side of the microscope module opposite to the image capturing module. A shortest distance between the sample inspecting surface and the convex lens ranges from 0.1 mm to 3.0 mm. The light guide element, which is disposed adjacent to the convex lens, has a light input portion and a light output portion. The light output portion is located between the image capturing module and the convex lens. The light input portion receives a light, and the light is outputted through the light output portion to the convex lens. The light enters the convex lens through a light input surface of the convex lens, leaves the convex lens through a light output surface of the convex lens, and then reaches the sample inspecting surface.

To achieve the above objective, the present invention further discloses a microscope device, which includes a microscope module and an image capturing module connecting to the microscope module. The microscope module includes a housing, a convex lens and a light guide element. The housing has a sample inspecting surface located on one side of the housing opposite to the image capturing module. The convex lens is disposed in the housing, and a shortest distance between the sample inspecting surface and the convex lens ranges from 0.1 mm to 3.0 mm. The light guide element is disposed adjacent to the convex lens. The light guide element has a light input portion and a light output portion. The light output portion is located between the image capturing module and the convex lens. The light input portion receives a light. The light is then outputted through the light output portion to the convex lens, enters the convex lens through a light input surface of the convex lens, leaves the convex lens through a light output surface of the convex lens, and then reaches the sample inspecting surface.

In one embodiment, the light guide element has a bar structure or an annular structure.

In one embodiment, the light guide element has a groove having a first slant surface and a second slant surface, and an included angle between the first slant surface and the second slant surface ranges from 45 degrees to 120 degrees.

In one embodiment, the light input portion has a hemispherical structure or an arc structure.

In one embodiment, the light guide element has a light shielding layer.

In one embodiment, the light is provided from an environmental light or a flash of the image capturing module.

In one embodiment, the light input portion is disposed adjacent to a flash of the image capturing module, and the light is provided by the flash.

In one embodiment, the convex lens has a wing portion disposed at an edge of the convex lens.

In one embodiment, the microscope module further includes a connecting element for connecting the light guide element and the image capturing module.

In one embodiment, the connecting element includes an adhesive layer, a connecting clip, or a hinge.

In one embodiment, the connecting element includes a cover connecting to the image capturing module.

In one embodiment, the connecting element includes a screw or a locking unit for connecting to the image capturing module by screwing or locking.

In one embodiment, the microscope module further includes a backlight unit disposed at one side of the housing away from the image capturing module.

In one embodiment, the backlight unit has a sample accommodating portion located at one side of the backlight unit close to the sample inspecting surface.

In one embodiment, the microscope module further includes a transparent substrate disposed at one side of the housing away from the image capturing module, and the sample inspecting surface is located on an external surface of the transparent substrate.

In one embodiment, the microscope module further includes an adhesive element disposed on one side of the housing configured with the sample inspecting surface.

In one embodiment, the housing has a light output hole close to the sample inspecting surface, and a ratio of an aperture of the light output hole to a diameter of the convex lens ranges between 1 and 1.5.

In one embodiment, the microscope device further includes a wireless communication module for transmitting an image retrieved by the image capturing module to an external device.

In one embodiment, the microscope device further includes an electronic connecting line for connecting the microscope module to the image capturing module.

In one embodiment, the microscope device further includes a circuit board having a control chip.

In one embodiment, the microscope device further includes an adhesive element disposed on one side of the housing configured with the sample inspecting surface.

As mentioned above, the microscope module and device of the invention have novel designs of the convex lens and the light traveling path through the light guide element. In detailed, the light input portion of the light guide element can receive a light, and the light output portion of the light guide element is disposed between the image capturing module and the convex lens. Accordingly, the light can enter the convex lens through an input surface of the convex lens, leaves the convex lens through an output surface of the convex lens, and then reaches the sample inspecting surface, thereby providing the light for inspecting the sample so as to execute the microscope function. In addition, since the light guide element is disposed between the image capturing module and the convex lens, the volumes of the microscope module and microscope device can be sufficiently reduced, thereby achieving the purpose of the portable microscope module and microscope device.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing the combination of an image capturing module and a microscope module according to an embodiment of the invention;

FIG. 2 is a sectional view of the microscope module of FIG. 1;

FIG. 3 is an exploded view of the microscope module of FIG. 1;

FIGS. 4A to 4D are schematic diagrams of using the microscope module of FIG. 2 to inspect a sample;

FIGS. 4E to 4G are schematic diagrams of various aspects of the adhesive element;

FIG. 5A is a schematic diagram showing an aspect of the connecting element of FIG. 1;

FIG. 5B is a schematic diagram showing another aspect of the connecting element of FIG. 1;

FIG. 5C is a schematic diagram showing another aspect of the connecting element of FIG. 1;

FIG. 5D is a schematic diagram showing another aspect of the connecting element of FIG. 1;

FIG. 6 is a schematic diagram showing a microscope module of another embodiment cooperated with an image capturing module;

FIG. 7 is a sectional view of the microscope module of another embodiment cooperated with the image capturing module; and

FIG. 8 is a schematic diagram showing a microscope device according to an embodiment of the invention.

### DETAILED DESCRIPTION OF THE INVENTION

The present invention will be apparent from the following detailed description, which proceeds with reference to the accompanying drawings, wherein the same references relate to the same elements.

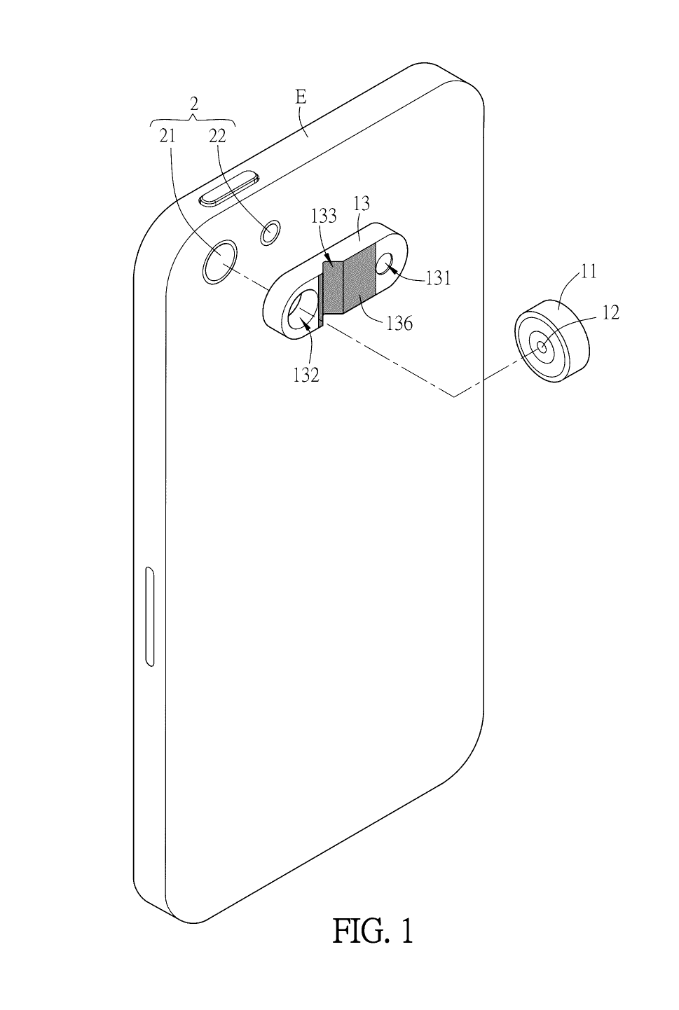

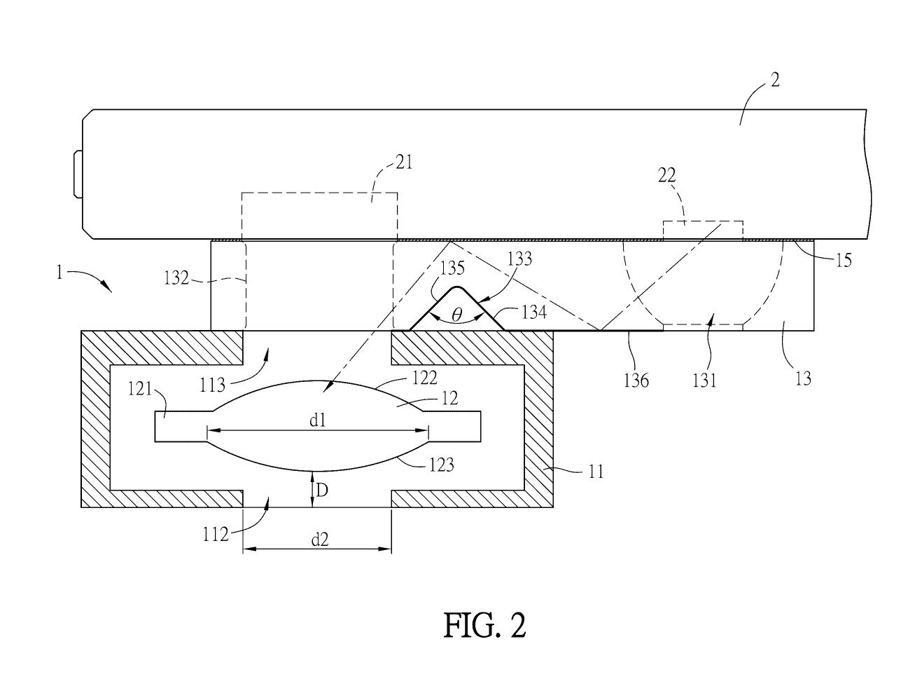

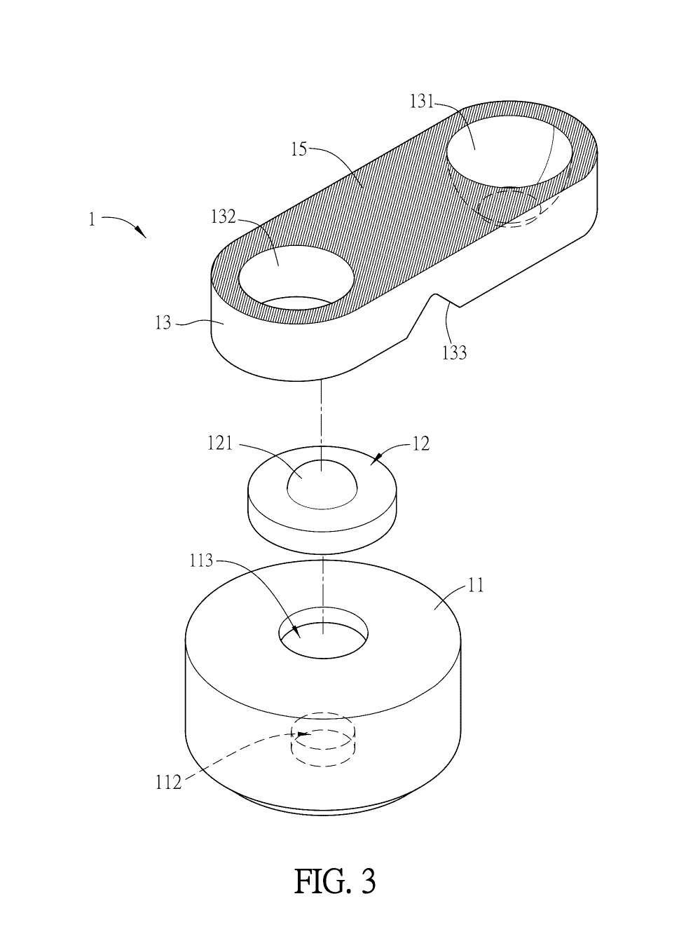

FIG. 1 is a schematic diagram showing the combination of an image capturing module and a microscope module according to an embodiment of the invention, FIG. 2 is a sectional view of the microscope module of FIG. 1 with showing the relative position of the image capturing module 2, and FIG. 3 is an exploded view of the microscope module of FIG. 2. Referring to FIGS. 1 to 3, the microscope module 1 includes a housing 11, a convex lens 12 and a light guide element 13. As shown in FIG. 1, the microscope module 1 is cooperated with an image capturing module 2, and the image capturing module 2 can be installed in an electronic device E, such as a mobile communication device, a smart phone, a tablet computer, a digital camera, a driving recorder, a notebook computer, a microscope or a wearable electronic device. In this embodiment, the electronic device E is a mobile communication device for example. That is, the microscope module 1 of this embodiment is directly cooperated with the image capturing module 2 of the electronic device E. In this embodiment, the convex lens 12 is disposed in the housing 11, and one side of the housing 11 is installed on the electronic device E. The installation of the housing 11 on the electronic device E will be discussed later. The other side of the housing 11 is directly placed on the sample, or the sample is placed on the housing 11. Then, the image capturing module 2 retrieves the image of the sample through the microscope module 1, thereby providing the enlarged sample image for inspection. To be noted, the image capturing module 2 is shown as a block in FIG. 2. The sample to be inspected in this embodiment can be, for example but not limited to, leather, jewelry, jade, biological sample, or skin.

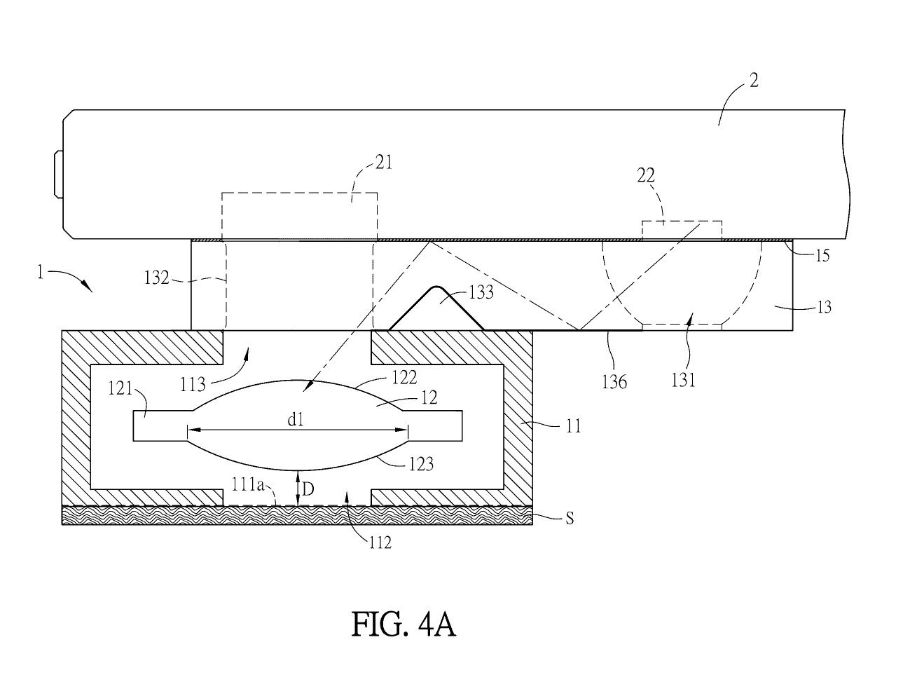

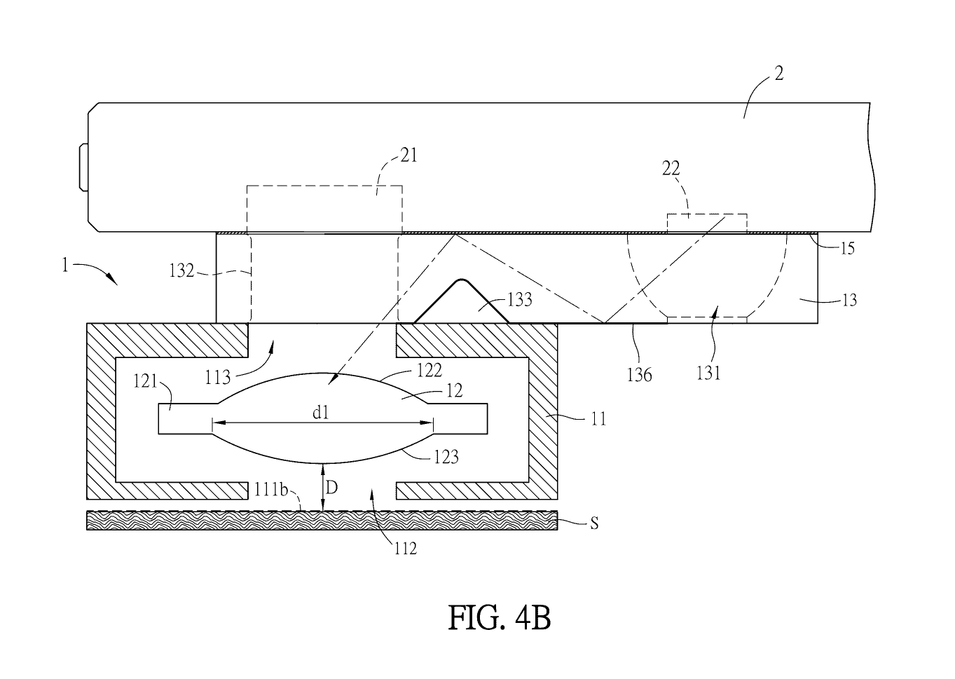

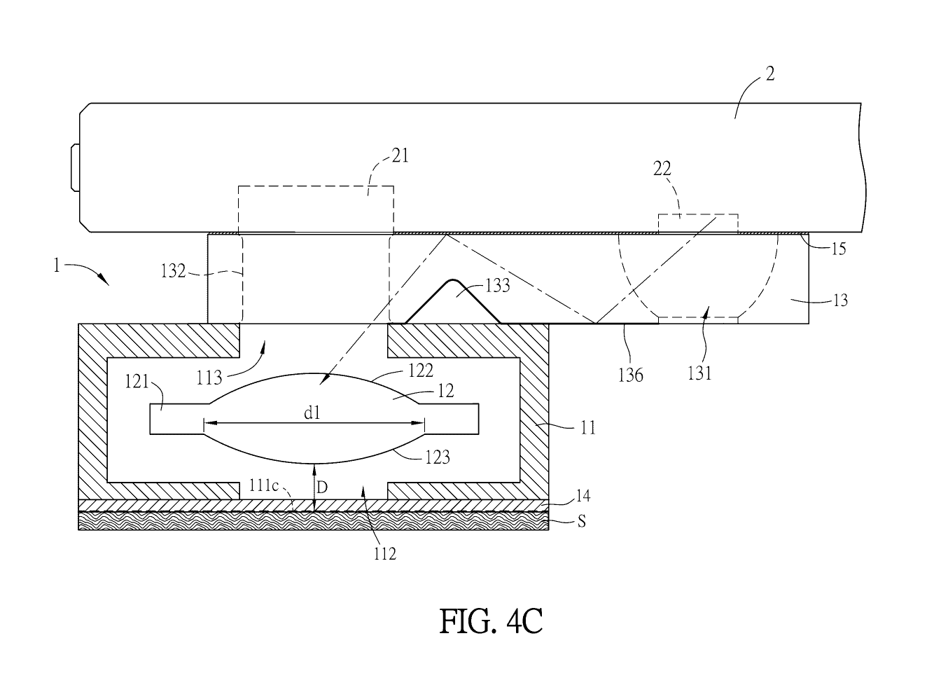

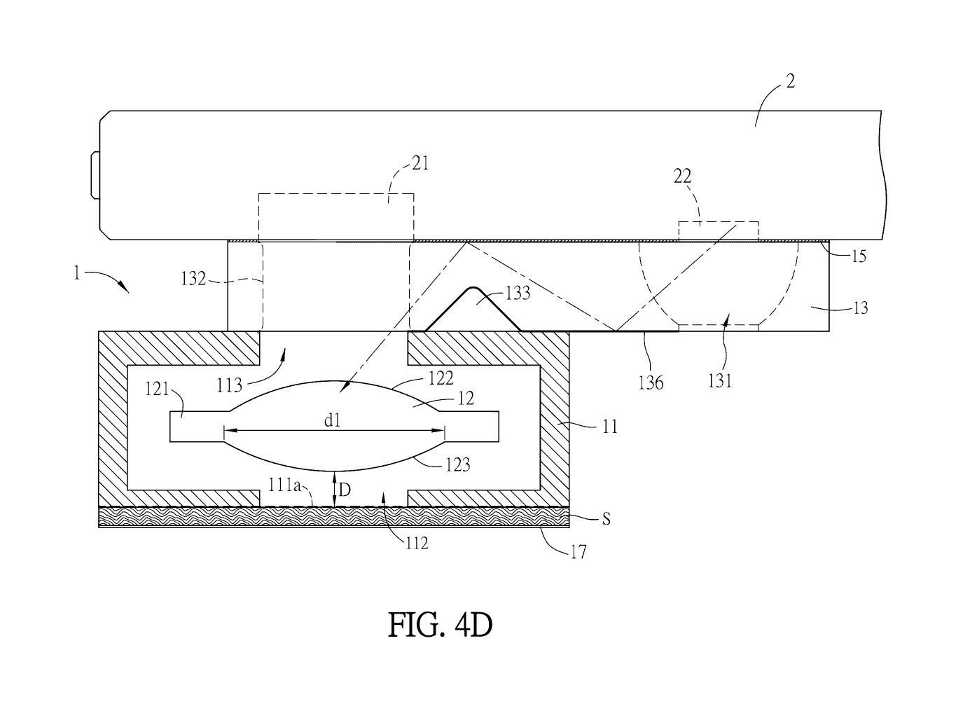

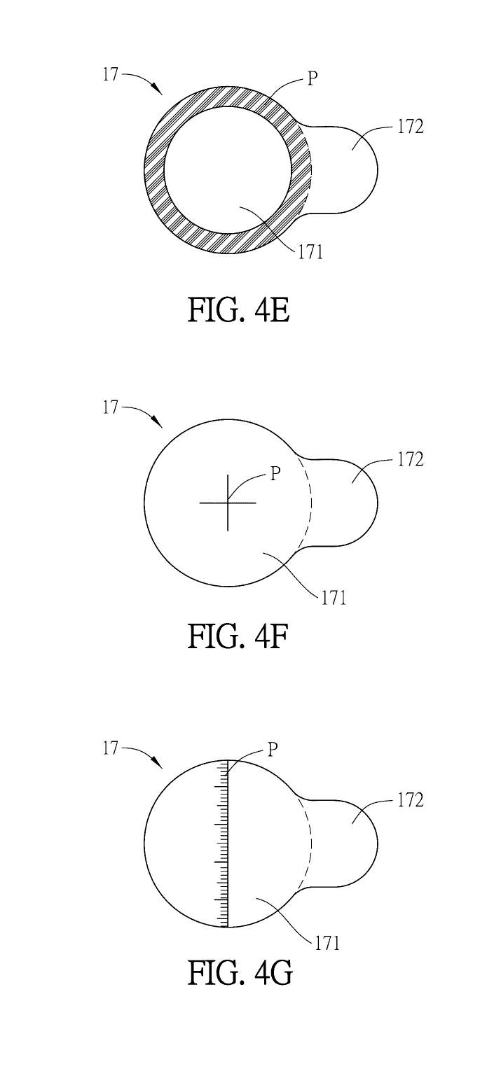

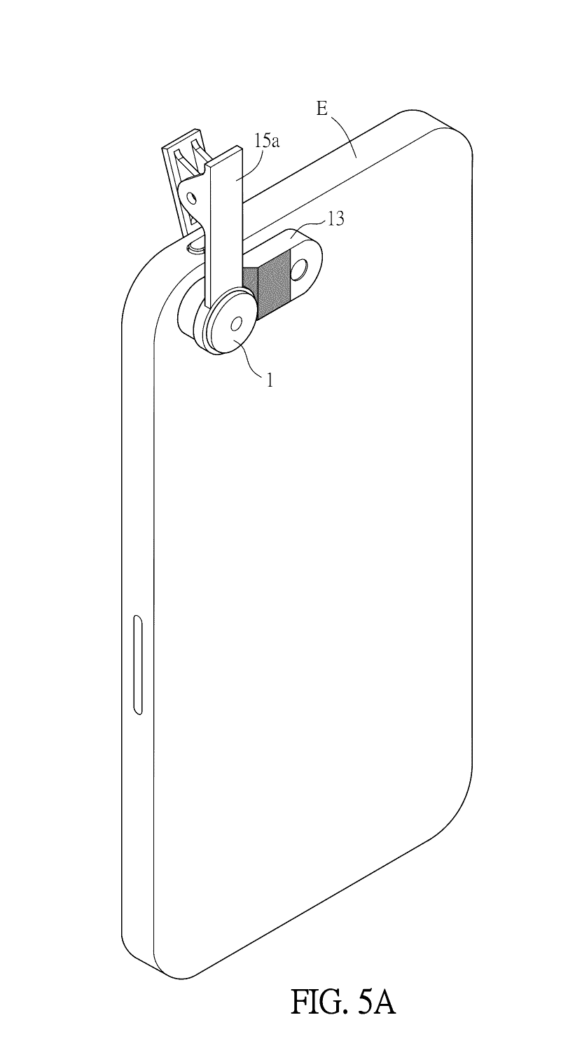

FIGS. 4A to 4C are schematic diagrams of using the microscope module 1 of FIG. 2 to inspect a sample. To be noted, the sample S in FIGS. 4A to 4C can be any object to be inspected such as the bio sample itself or the combination of the bio sample and other components (e.g. slide or sticker). For example, the sample S can be a skin sample. Otherwise, the microscope module 1 can be placed on the body for inspecting the skin of the body. Referring to FIG. 4A, the housing 11 has a sample inspecting surface 111a, which is located on one side of the housing 11 opposite to the image capturing module 2. To be noted, the sample inspecting surface 111a can be a physical surface or a virtual surface. As shown in FIG. 4A (the sample inspecting surface 111a is a physical surface), when the sample S is contacted with the housing 11, the sample inspecting surface 111a is substantially the surface of the side of the housing 11 opposite to the image capturing module 2. As shown in FIG. 4B (the sample inspecting surface 111a is a virtual surface), when the sample S and the housing 11 are departed with a little distance, the sample inspecting surface 111b is the surface of the sample S close to the microscope module 1. In one embodiment, as shown in FIG. 4C, the microscope module 1 further includes a transparent substrate 14 disposed at one side of the housing 11 away from the image capturing module 2. In this case, the sample inspecting surface 111c is located on the external surface of the transparent substrate 14.

FIG. 4D is a schematic diagram of using the microscope module 1 of FIG. 2 to inspect a sample. In more detailed, the microscope module 1 further includes an adhesive element 17, and the sample S is prepared by using the adhesive element 17 to contact the bio sample S′. The adhesive element 17 can be a sticker having an adhesive surface. The adhesive element 17 has an adhesive area 171 and a non-adhesive area 172. The adhesive area 171 is configured to catch the bio sample S′ and then attach to the transparent substrate 14. Since the transparent substrate 14 is usually the slide commonly used in the lab, the size of the adhesive element 17 is preferably smaller than the normal slide. For example, the diameter of the adhesive area 171 is smaller than or equal to 2.5 cm. The non-adhesive area 172 is configured to be held by the user. In one embodiment, an easy tearing line L is formed between the adhesive area 171 and the non-adhesive area 172. When the user wants to seal the bio sample S′, the user can easily detach the non-adhesive area 172 from the adhesive area 171 so that the part of the adhesive element 17 protruding from the transparent substrate 14 can be removed. This design can help to easily preserve the sample S. The adhesive element 17 is disposed at one side of the housing opposite to the sample inspecting surface 111. Besides, the adhesive element 17 can be made of opaque materials for improving the contrast of the image, so that the user can observe the dark field effect under the microscope module 1. But, this invention is not limited thereto. In some embodiments, the adhesive element 17 may be made of a light-permeable material. For example, the transmittance of the adhesive element 17 is larger than 90%. In this case, the adhesive element 17 can be located at the same side as the sample inspecting surface 111 (not shown).

FIGS. 4E to 4G are top views of the adhesive element 17. The adhesive element 17 has a pattern P located in area corresponding to the adhesive area 171 (on the adhesive surface or the non-adhesive surface) for facilitating the following inspection. In practice, the user has to move the sample S to position the bio sample S′ within the inspection field of the microscope module 1. However, when the user uses the microscope module 1 to inspect the bio sample S′, it is hard to distinct the relative positions of the bio sample S′ and the inspection field. In this case, the configuration of the pattern P can assist the user to rapidly recognize the relative positions of the bio sample S′ and the inspection field. For example, as shown in FIG. 4E, the pattern P is an annular pattern disposed at the edge of the adhesive area 171. When the user views the pattern P within the inspection field, he or she can easily realize that the inspection field is located on the edge of the adhesive area 171 and then properly move the sample S for the following inspection. As shown in FIG. 4F, the pattern P is a cross pattern located at the center of the adhesive area 171. When the user views the pattern P within the inspection field, he or she can easily realize that the inspection field aims to the center of the adhesive area 171. In addition, it is desired to inspect the real size of the bio sample S′ by the observation through the microscope module 1. Accordingly, as shown in FIG. 4G the pattern P includes a scale so that the user can directly measure the size of the bio sample S′ under the inspection field.

The convex lens 12 of this embodiment is an aspherical lenticular lens. A shortest distance D between the sample inspecting surface 111a (or the sample inspecting surface 111b or 111c) and the surface of the convex lens 12 ranges from 0.1 mm to 3.0 mm, preferably from 0.3 mm to 2.0 mm, and more preferably from 0.5 mm to 1.2 mm. Accordingly, the magnification of the microscope module 1 is between 100× and 200×. In this embodiment, the convex lens 12 has a wing portion 121 disposed at an edge of the convex lens 12. In more detailed, the center portion of the convex lens 12 has the structure of an aspherical lenticular lens, and the edge of the convex lens 12 has the structure of flat wing portion 121. The wing portion 121 is nothing to do with the captured image, so the length of wing portion 121 is not limited.

In addition, the light guide element 13 is disposed on the external surface of the housing 11 and is located adjacent to the convex lens 12. In this embodiment, the light guide element 13 can guide the light from the light source outside the housing 11 to the convex lens 12. In more specific, as shown in FIG. 2, the light guide element 13 has a light input portion 131 and a light output portion 132. The light output portion 132 is located between the image capturing module 2 and the convex lens 12. The light input portion 131 receives a light, which is from the environmental light or a flash 22 of the image capturing module 2. In this embodiment, the light is from a flash 22 of the image capturing module 2. The light input portion 131 is positioned adjacent to the flash 22 of the image capturing module 2. Preferably, the top surface of the light input portion 131 has an opening for receiving the light from the environmental light or the flash 22. After the light input portion 131 of the light guide element 13 receives the light from the flash 22, the light is then outputted through the light output portion 132 to the convex lens 12.

The light guide element 13 may have a bar structure or an annular structure. Since the light input portion 131 is used to receive the light from the flash 22, the position of the light input portion 131 is corresponding to the flash 22. The position of the light output portion 132 is corresponding the lens 21 of the image capturing module 2. Since the lens 21 and the flash 22 of the image capturing module 2 are usually departed with a distance, the light guide element 13 correspondingly has a bar structure. Of course, in other embodiments, if the light input portion 131 is configured to receive the environmental light, the light input portion 131 can be an annular structure. This invention is not limited.

Preferably, the light input portion 131 has a hemispherical structure or an arc structure for providing a wider surface to receive the light. Preferably, the light guide element 13 has a groove 133 having a first slant surface 134 and a second slant surface 135 (see FIG. 2). An included angle θ between the first slant surface 134 and the second slant surface 135 ranges from 45 degrees to 120 degrees. The configuration of the groove 133 can efficiently guide the light received by the light input portion 131 to the light output portion 132, and then the light can be emitted to the convex lens 12 from the light output portion 132. Preferably, as shown in FIGS. 1 and 2, the light guide element 13 has a light shielding layer 136, such as a dark coating, coated between the light input portion 131 and the light output portion 132 for preventing the undesired environmental light to enter the light output portion 132.

According to the above configuration, the light emitted from the light output portion 132 enters the convex lens 12 through a light input surface 122 of the convex lens 12, leaves the convex lens 12 through a light output surface 123 of the convex lens 12, and then reaches the sample inspecting surface 111a. The housing 11 includes a light output hole 112 and an opening 113. The light output hole 112 is disposed on one side of the housing 11 close to the sample inspecting surface 111a, and the opening 113 is located on another side of the housing 11 close to the image capturing module 2. In practice, the light emitted from the light output portion 132 enters the convex lens 12 through an input surface 122 of the convex lens 12, leaves the convex lens 12 through an output surface 123 of the convex lens 12, passes through the light output hole 112, and then reaches the sample inspecting surface 111a. After reflected from the sample inspecting surface 111a, the light enters the convex lens 12 through the light output surface 123 of the convex lens 12, leaves the convex lens 12 through the input surface 122 of the convex lens 12, passes through the opening 113, and then reaches the lens 21 of the image capturing module 2. Afterwards, the image capturing module 2 captures the enlarged sample image, and then the electronic device E can perform an image treatment process so as to display the sample image through the displaying unit of the electronic device E. Finally, the user can directly observe the enlarged sample image on the electronic device E.

As shown in FIG. 2, the convex lens 12 has a diameter d1. In this embodiment, the aspherical lenticular portion of the convex lens 12 has a diameter d1. That is, the diameter d1 does not cover the wing portion 121. The light output hole 112 has an aperture d2, and a ratio of the aperture d2 to the diameter d1 ranges between 1 and 1.5. This configuration can block the environmental light from entering the convex lens 12, thereby preventing the undesired interference to the sample image caused by the environmental light.

As shown in FIG. 2, the microscope module 1 may further include a connecting element 15 for connecting the light guide element 13 to the image capturing module 2. In more specific, the connecting element 15 is disposed on the external surface of the light guide element 13 close to the image capturing module 2 for connecting to the image capturing module 2. In this embodiment, the connecting element 15 is an adhesive layer, and preferably a pressure sensitive adhesive, which is sensitive to pressure and is reusable. The housing 11 and the light guide element 13 of the microscope module 1 can be connected by an adhesive layer or other connecting components, or they can be integrally formed as one piece. Accordingly, the entire microscope module 1 can be attached to the electronic device E by the connecting element 15 (adhesive layer), and the opening 113 is aligned to the lens 21 of the image capturing module 2. Thus, the microscope module 1 and the image capturing module 2 are assemble for following operation.

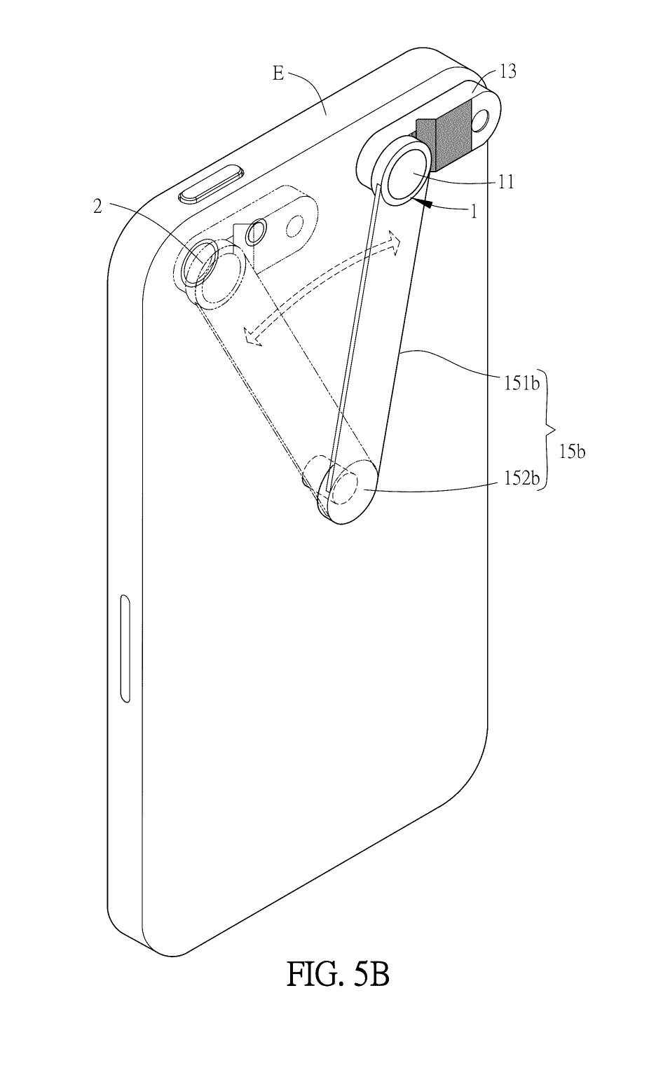

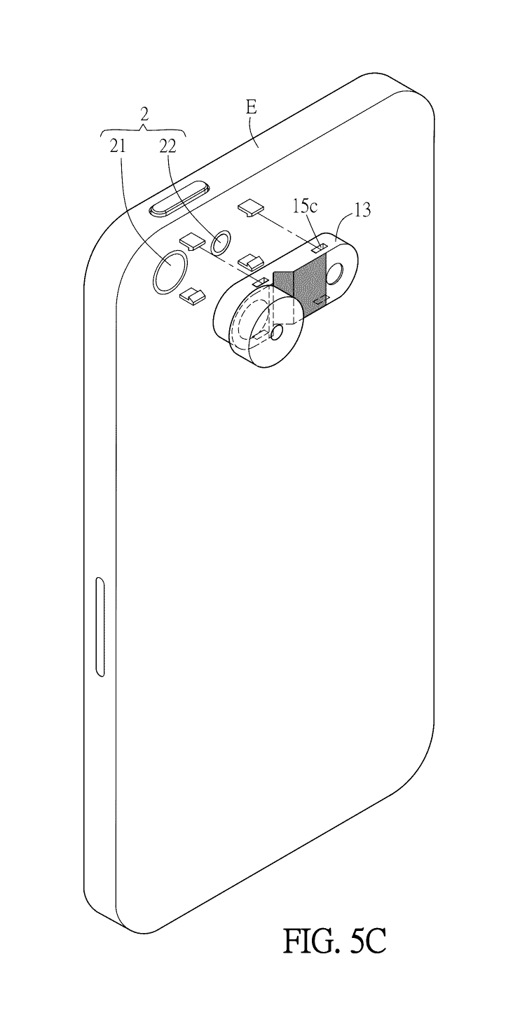

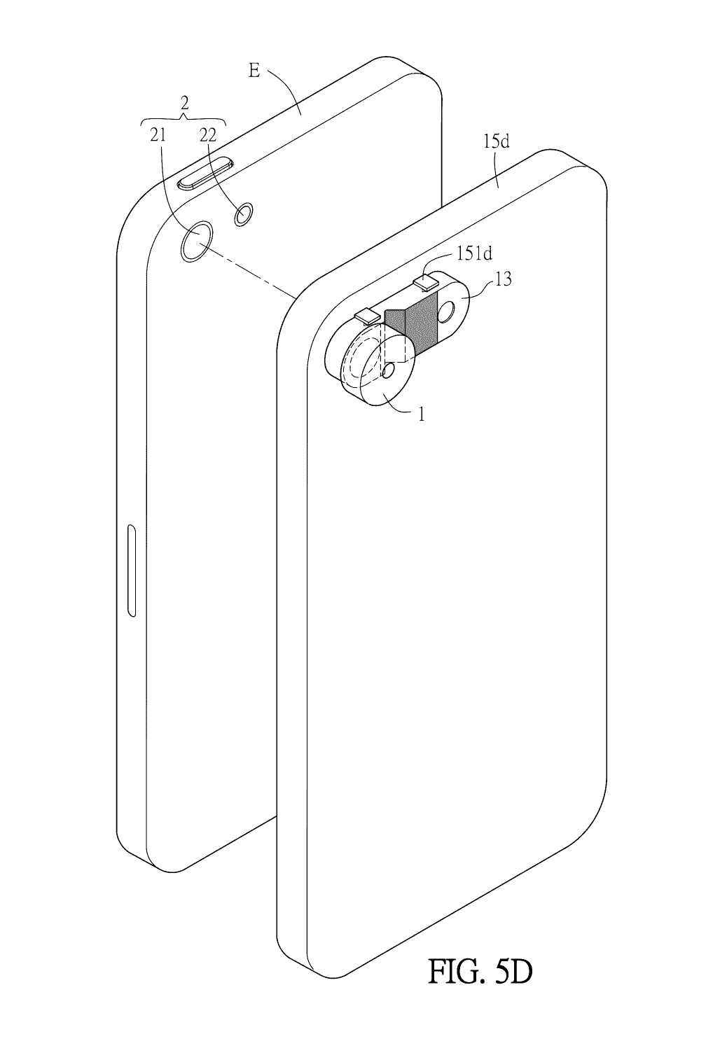

FIG. 5A is a schematic diagram showing an aspect of the connecting element of FIG. 1. As shown in FIG. 5A, the connecting element 15a is a connecting clip for directly clipping the microscope module 1 to the electronic device E, and the opening 113 is aligned to the lens 21 of the image capturing module 2. In more detailed, one end of the connecting element 15a (connecting clip) is connected to the housing 11 of the microscope module 1, so the housing 11 along with the components disposed within the housing 11 can be assembled with the connecting element 15a in advance. The other end of the connecting element 15a (connecting clip) directly clips the light guide element 13 and the electronic device E, and the position of the light guide element 13 is corresponding to the lens 21 of the image capturing module 2. Thus, the housing 11 of microscope module 1 can be assembled with the connecting element 15a in advance. Afterwards, the connecting element 15a along with the light guide element 13 is clipped to the electronic device E, and the opening 113 is aligned to the lens of the image capturing module 2. Accordingly, the light can be reflected from the sample, pass through the light output hole 112, the convex lens 12 and the opening 113, and then reach the image capturing module 2 (referring to FIG. 2).

FIG. 5B is a schematic diagram showing another aspect of the connecting element of FIG. 2. As shown in FIG. 5B, the connecting element 15b is a hinge. In more detailed, the connecting element 15b includes an axial portion 151b and a pivotal portion 152b. One end of the axial portion 151b is fixed on the housing 11 of the microscope module 1. For example, the axial portion 151b can be directly adhered to the housing 11, or connected to the housing 11 by screwing or locking. This invention is not limited. The other end of the axial portion 151b is connect to the pivotal portion 152b, which is disposed on the housing of the electronic device E, so that the light guide element 13 and the image capturing module 2 can be connected by the connecting element 15b. Accordingly, the connecting element 15b can connect the image capturing module 2 and the entire microscope module 1. The user can move the axial portion 151b to slide the microscope module 1 on the housing of the electronic device E about the pivotal portion 152b. Since the connecting element 15b is a hinge structure, the microscope module 1 can be generally installed on the housing of the electronic device E. When the user needs the microscope function, he or she can pull the axial portion 151b to align the opening 113 of the microscope module 1 with the lens of the image capturing module 2 (referring to FIG. 2).

FIG. 5C is a schematic diagram showing another aspect of the connecting element of FIG. 1. As shown in FIG. 5C, the connecting element 15c includes a screw or a locking unit for connecting to the image capturing module 2 by screwing or locking. In this embodiment, the connecting element 15c is a locking structure. In this embodiment, the light guide element 13 has a recess portion (the connecting element 15c), and the housing of the electronic device E has a corresponding hooking structure, so that the light guide element 13 and the image capturing module 2 can be connected by the connection of the recess portion and the hooking structure. Besides, the light guide element 13 can also be connected to the housing 11 of the microscope module 1 by adhering, magnetic attraction, locking or the likes. Thus, when the light guide element 13 is connected to the image capturing module 2, the entire microscope module 1 can also be connected to the image capturing module 2.

FIG. 5D is a schematic diagram showing another aspect of the connecting element of FIG. 1. In this embodiment, the connecting element 15d is a cover, which is configured for protecting the back cap of the electronic device E. The cover has a locking portion 151d located corresponding to the lens 21 and the flash 22 of the image capturing module 2. The light guide element 13 has a recess portion for connecting to the locking portion 151d. In practice, the user can mount the connecting element 15d (cover) on the housing of the electronic device E. When the user needs the microscope function, he or she can install the light guiding element 13 to the connecting element 15d (cover) by locking. Besides, the light guide element 13 can also be connected to the housing 11 of the microscope module 1 by adhering, magnetic attraction, locking or the likes. Thus, when the light guide element 13 is connected to the image capturing module 2, the entire microscope module 1 can also be connected to the image capturing module 2.

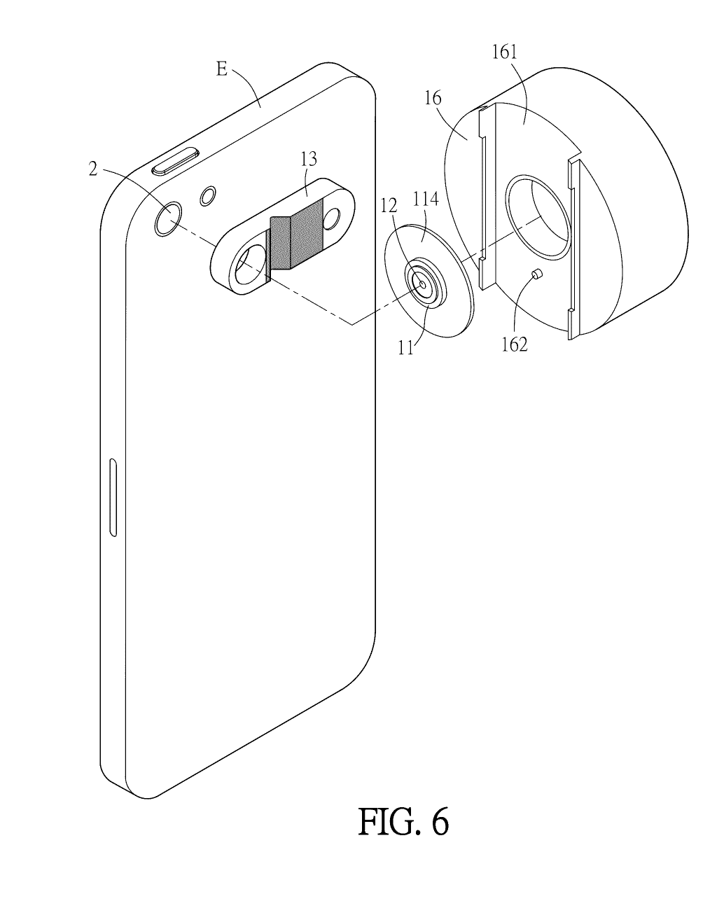

FIG. 6 is a schematic diagram showing a microscope module of the embodiment cooperated with an image capturing module. As shown in FIG. 6, the microscope module 1 may further include a backlight unit 16 disposed at one side of the housing 11 away from the image capturing module 2, and the sample is placed between the housing 11 and the backlight unit 16. In this embodiment, the microscope module of this embodiment can be applied to the sample with higher transmittance, such as the jewelries or jades. The backlight unit 16 can emit the auxiliary light to help the inspection. The sample reflects the auxiliary light to the convex lens 12, and then the image capturing module 2 receives the reflected auxiliary light. Preferably, the backlight module 16 has a sample accommodating portion 161 located at one side of the backlight unit 16 close to the sample inspecting surface 111 (referring to FIGS. 4A to 4C) for accommodating the sample. Preferably, the external surface of the housing 11 is configured with a magnet portion 114, and the material of the backlight unit 16 can be attracted by the magnet portion 114. Thus, the housing 11 and the backlight unit 16 can be fixed to each other. The user can press the power switch 162 of the backlight unit 16 for activating the backlight unit 16.

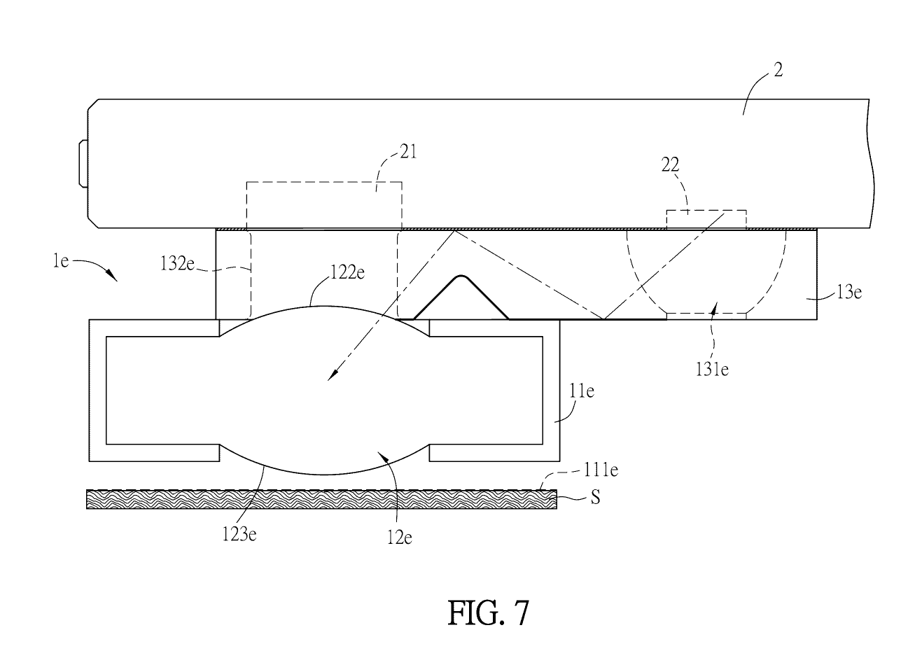

FIG. 7 is a sectional view of the microscope module of the embodiment cooperated with the image capturing module. Referring to FIG. 7, the microscope module 1e is cooperated with an image capturing module 2e and includes a sample inspecting surface 111e, a convex lens 12e and a light guide element 13e. Preferably, the microscope module 1e includes a housing 11e, which is made of a transparent material, and the housing 11e and the convex lens 12e are integrally formed as one piece. The sample inspecting surface 111e is located on one side of the microscope module 11e opposite to the image capturing module 2e. To be noted, the sample inspecting surface 111e can be a physical surface or a virtual surface (as the sample inspecting surface 111 of the previous embodiment). That is, the sample inspecting surface 111e can be substantially the surface of the side of the housing 11e opposite to the image capturing module 2e or the surface of the sample S close to the microscope module 1e (see FIG. 7). The details of the microscope module 1e and the sample inspecting surface 111e can be referred to the illustrations of FIGS. 4A to 4C, so the detailed descriptions thereof will be omitted.

A shortest distance D between the sample inspecting surface 111e and the convex lens 12e ranges from 0.6 mm to 3.0 mm. The light guide element 13e has a light input portion 131e and a light output portion 132e, which is disposed between the image capturing module 2e and the convex lens 12e. The light input portion 131e receives the light emitted from the flash 22e, and the light is outputted from the light output portion 132e to the convex lens 12e. Then, the light enters the convex lens 12e through an input surface 122e of the convex lens 12e, leaves the convex lens 12e through an output surface 123e of the convex lens 12e, and then reaches the sample inspecting surface 111e. The details of the relative components can be referred to the previous embodiment, so the descriptions thereof will be omitted.

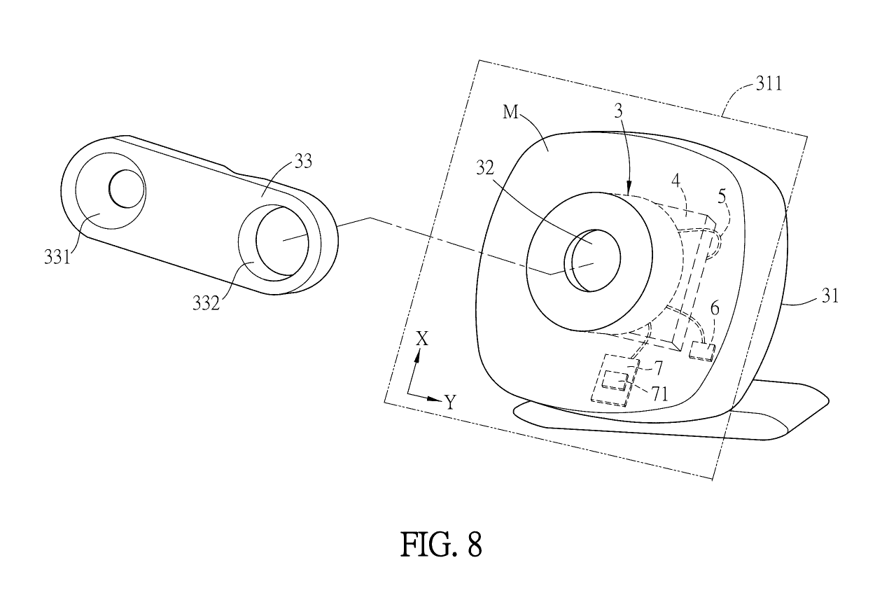

The microscope module 1 and the electronic device E can be assembled, so that the image capturing module 2 of the electronic device E and the microscope module 1 can cooperate to form a microscope device and provide a microscope function. In one embodiment, the microscope module 1 is directly assembled with the image capturing module 2 to form the microscope device M. FIG. 8 is a schematic diagram showing a microscope device M according to an embodiment of the invention. As shown in FIG. 8, the microscope device M includes a microscope module 3 and an image capturing module 4, which are connected to each other. In this embodiment, the microscope device M further includes an electronic connecting line 5 for connecting the microscope module 3 to the image capturing module 4. The microscope module 3 includes a housing 31, a convex lens 32 and a light guide element 33. In this embodiment, the convex lens 32 and the image capturing module 4 are all disposed within the housing 31, and the light guide element 33 is disposed outside the housing 31.

Similarly, the housing 31 has a sample inspecting surface 311 disposed at one side of the housing 31 opposite to the image capturing module 4. The details of the sample inspecting surface 311 can be referred to the sample inspecting surface 111a (or 111b/111c) of the previous embodiment, so the description thereof will be omitted. Similarly, the shortest distance D between the sample inspecting surface 311 and the convex lens 32 ranges from 0.1 mm to 3.0 mm, preferably from 0.3 mm to 2.0 mm, and more preferably from 0.5 mm to 1.2 mm.

The light guide element 33 also has a light input portion 331 and a light output portion 332, which is located between the image capturing module 4 and the convex lens 32. The light input portion 331 receives a light, and the light is then outputted through the light output portion 332 to the convex lens 32. As mentioned above, the light enters the convex lens 32 through an input surface of the convex lens 32, leaves the convex lens 32 through an output surface of the convex lens 32, and then reaches the sample inspecting surface 311. After reflected from the sample inspecting surface 311, the light passes through the convex lens 32 and is then received by the image capturing module 4. Preferably, the microscope device M further includes a wireless communication module 6 and a circuit board 7. The circuit board 7 includes a control chip 71. The configuration of the wireless communication module 6 allows to transmit an image retrieved by the image capturing module 4 to an external device. In more specific, the control chip 71 controls the image capturing module 4 to capture the enlarged sample image, and then performs an image treatment process. Afterwards, the enlarged sample image is transmitted to the external device (e.g. the display unit of another electronic device) through the wireless communication module 6. Accordingly, the user can observe the sample image enlarged by the microscope module 3 in another electronic device. The detailed actions of the microscope module 3 and the image capturing module 4 can be referred to the previous embodiments, so the description thereof will be omitted.

In summary, the microscope module and device of the invention have novel designs of the convex lens and the light traveling path through the light guide element. In detailed, the light input portion of the light guide element can receive a light, and the light output portion of the light guide element is disposed between the image capturing module and the convex lens. Accordingly, the light can enter the convex lens through an input surface of the convex lens, leaves the convex lens through an output surface of the convex lens, and then reaches the sample inspecting surface, thereby providing the light for inspecting the sample so as to execute the microscope function. In addition, since the light guide element is disposed between the image capturing module and the convex lens, the volumes of the microscope module and microscope device can be sufficiently reduced, thereby achieving the purpose of the portable microscope module and microscope device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A microscope module, which is cooperated with an image capturing module, comprising:
a housing having a sample inspecting surface, which is located on one side of the housing opposite to the image capturing module;
a convex lens disposed in the housing, wherein a shortest distance between the sample inspecting surface and the convex lens ranges from 0.1 mm to 3.0 mm; and
a light guide element disposed on an external portion of the housing, wherein the light guide element has a light input portion and a light output portion, the light output portion is located between the image capturing module and the convex lens, the light input portion receives a light, and the light is outputted through the light output portion to the convex lens;
wherein, the light enters the convex lens through a light input surface of the convex lens, leaves the convex lens through a light output surface of the convex lens, and then reaches the sample inspecting surface.

2. The microscope module of claim 1, wherein the light guide element has a bar structure or an annular structure.

3. The microscope module of claim 1, wherein the light guide element has a groove having a first slant surface and a second slant surface, and an included angle between the first slant surface and the second slant surface ranges from 45 degrees to 120 degrees.

4. The microscope module of claim 1, wherein the light guide element has a light shielding layer.

5. The microscope module of claim 1, wherein the light input portion is disposed adjacent to a flash of the image capturing module, and the light is provided by the flash.

6. The microscope module of claim 1, wherein the convex lens has a wing portion disposed at an edge of the convex lens.

7. The microscope module of claim 1, further comprising:
a connecting element connecting the light guide element and the image capturing module.

8. The microscope module of claim 1, further comprising:
a backlight unit disposed at one side of the housing away from the image capturing module.

9. The microscope module of claim 1, further comprising:
a transparent substrate disposed at one side of the housing away from the image capturing module, wherein the sample inspecting surface is located on an external surface of the transparent substrate.

10. The microscope module of claim 1, further comprising:
an adhesive element disposed on one side of the housing configured with the sample inspecting surface.

11. The microscope module of claim 1, wherein the housing has a light output hole close to the sample inspecting surface, and a ratio of an aperture of the light output hole to a diameter of the convex lens ranges between 1 and 1.5.

12. A microscope module, which is cooperated with an image capturing module, comprising:
a sample inspecting surface located at one side of the microscope module opposite to the image capturing module;
a convex lens, wherein a shortest distance between the sample inspecting surface and the convex lens ranges from 0.1 mm to 3.0 mm; and
a light guide element disposed adjacent to the convex lens, wherein the light guide element has a light input portion and a light output portion, the light output portion is located between the image capturing module and the convex lens, the light input portion receives a light, and the light is outputted through the light output portion to the convex lens;
wherein, the light enters the convex lens through a light input surface of the convex lens, leaves the convex lens through a light output surface of the convex lens, and then reaches the sample inspecting surface.

13. A microscope device, comprising:
a microscope module, comprising:
a housing having a sample inspecting surface, wherein the sample inspecting surface is located on one side of the housing, which is opposite to the image capturing module,
a convex lens disposed in the housing, wherein a shortest distance between the sample inspecting surface and the convex lens ranges from 0.1 mm to 3.0 mm, and
a light guide element disposed adjacent to the convex lens, wherein the light guide element has a light input portion and a light output portion, the light output portion is located between the image capturing module and the convex lens, the light input portion receives a light, and the light is then outputted through the light output portion to the convex lens, enters the convex lens through a light input surface of the convex lens, leaves the convex lens through a light output surface of the convex lens, and then reaches the sample inspecting surface; and
an image capturing module connecting to the microscope module.

14. The microscope device of claim 13, wherein the light guide element has a bar structure or an annular structure.

15. The microscope device of claim 13, wherein the light guide element has a groove having a first slant surface and a second slant surface, and an included angle between the first slant surface and the second slant surface ranges from 45 degrees to 120 degrees.

16. The microscope device of claim 13, wherein the light guide element has a light shielding layer.

17. The microscope device of claim 13, wherein the light input portion is disposed adjacent to a flash of the image capturing module, and the light is provided by the flash.

18. The microscope device of claim 13, wherein the convex lens has a wing portion disposed at an edge of the convex lens.

19. The microscope device of claim 13, wherein the microscope module further comprises:
a connecting element connecting the light guide element and the image capturing module.

20. The microscope device of claim 13, further comprising:
a backlight unit disposed at one side of the housing away from the image capturing module.

21. The microscope device of claim 13, further comprising:
a transparent substrate disposed at one side of the housing away from the image capturing module, wherein the sample inspecting surface is located on an external surface of the transparent substrate.

22. The microscope device of claim 13, further comprising:
an adhesive element disposed on one side of the housing configured with the sample inspecting surface.

23. The microscope device of claim 13, wherein the housing has a light output hole close to the sample inspecting surface, and a ratio of an aperture of the light output hole to a diameter of the convex lens ranges between 1 and 1.5.

24. The microscope device of claim 13, further comprising:
a wireless communication module for transmitting an image retrieved by the image capturing module to an external device.
